(19) United States
(12) Patent Application Publication
(10) Pub. No.: US 2006/0023258 A1
(43) Pub. Date: Feb. 2, 2006

(54) Method for minimizing boundary defects using halftone classes with matched harmonics

(75) Inventors: Robert P. Loce, Webster, NY (US); Charles M. Hains, Altaderia, CA (US); Beilei Xu, Penfield, NY (US); Connie F. Purdum, Rochester, NY (US); Xiaoxue Shirley Cheng, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 10/909,627

(22) Filed: Aug. 2, 2004

(51) Int. Cl. H04N 1/405

(52) U.S. Cl. 358/3.2

(57) ABSTRACT

A method for minimizing boundary effects when switching between halftone screens on a scanline, includes selecting a first halftone screen having a first fundamental frequency and a first angle for printing pixels of a first type; and selecting a second halftone screen having a second fundamental frequency and a second angle for printing pixels of a second type, wherein the second frequency and second angle are harmonically matched to the first frequency and first angle, wherein at least one pixel of the second type is adjacent to a pixel of the first type. In one embodiment, the first and second frequencies are selected to have a substantially zero frequency beat. In another, the first and second frequencies are selected to have a substantially high frequency beat.

### BACKGROUND AND SUMMARY

This invention relates generally to halftoning methods, and more particularly to a halftoning method for producing adjacent halftone screens with improved boundary appearance.

In object oriented halftoning, a different halftone screen is assigned to different object types. For example, text objects can be halftoned using a halftone screen which is optimized for text objects; background objects can be halftoned using a halftone screen which is optimized for background objects. Object oriented halftoning has been a long standing attractive idea with the long standing problem of the ragged appearance of the boundaries between adjacent halftones. During object oriented halftoning artifacts are created at the boundaries between two halftone screens. These artifacts give the appearance of ragged edges at boundaries of the printed objects.

The technical reason for edge artifacts is generally related to the different frequency vectors of the adjacent halftone screens.

Some production printers possess the capability to switch halftones on a pixel boundary. Consider an exemplary printer that can use several different halftones that can be switched on a pixel boundary. For printers with this capability, it can be desirable to utilize very low frequency halftones as a solution for achieving a high degree of uniformity in broad tinted areas. A medium frequency halftone can be preferred for image content with a medium degree of edge content. A high frequency screen can be desirable for rendering objects with sharp edges so those edges can be well defined. While the particular halftones may be optimal for a given object type, when different objects are adjacent, such as text on a tinted background, the appearance of the boundary can exhibit the raggedness artifact.

FIG. 1 shows an exemplary output printed by printer using two screens: a 170 cpi (cycles per inch) 45° screen for the background and a 212 cpi 45° screen for the text. The boundaries do not have a pleasing appearance, and excessively light and dark spots can be seen, especially in the lighter text. In practice, multiple color separations are often used in forming an image and one given separation can possess low contrast between text and tint, as shown in FIG. 1. FIG. 2 shows the frequency vector diagram for the halftoning condition described in FIG. 1. The orientations of the halftone frequencies are aligned, but the frequency components are not matched. The difference in the frequency vectors indicates the beat frequency at the interface. From the short length of this vector difference it can be seen that the beat is low frequency, and therefore objectionable.

U.S. Pat. No. 5,898,822 to Thomas Holladay for “Using the Phase Information in the Halftone Dot Structure to Minimize Artifacts when Switching Between Halftone Dots on a Scan Line” describes a method of reducing visible image artifacts that uses variable phase parameters (i.e., the standard x, y start position in halftone cells) during halftoning processes to match the phase of halftone cells and also uses a brick approach to halftoning. In Holladay, the position in a halftone dot structure is correlated to the phase of sine waves for subsequent dots to be used in a halftoning process. This method provides some beneficial properties to minimizing image artifacts caused by phase parameters, but it does not address all artifacts, such as the beating artifact at the boundary between objects that occurs in print engines which use low frequency halftone screens, that may result in printers that utilize object oriented halftone printing by adjacent halftone screens.

Disclosed in embodiments herein is a halftoning method for producing adjacent halftones with improved boundary appearance. The method operates by choosing halftones with matched harmonics. Halftone screens having matched harmonics are generally thought of as halftone screens with some number of resolvable spatial frequency components that are equal resulting in zero frequency beats. In some cases, halftone screens may be considered to have matched harmonics can include the high frequency beats. In this case halftone screens having matched harmonics are thought of as halftone screens where the frequency vectors are so dissimilar as to produce a very high frequency, nonobjectionable beat. In this later meaning, matched harmonics does not refer to an equality, rather it refers to a compatibility.

Examples of orthogonal screens such as dot screens and line screens with matched harmonics are described. For example, for a dot screen, one halftone screen is chosen to have double the frequency of the other and they are in phase. Multiple embodiments of matched harmonics exist and are presented here. The method may be employed in printers that utilize object oriented halftone printing.

In one embodiment, a method for minimizing boundary effects when switching between halftone screens for adjacent objects, include selecting a first halftone screen having a first fundamental frequency and a first angle for printing pixels of a first object type; and selecting a second halftone screen having a second fundamental frequency and a second angle for printing pixels of a second object type, wherein the second frequency and second angle are harmonically matched to the first frequency and the first angle, wherein at least one pixel of the second object type is adjacent to a pixel of the first object type.

In another embodiment, a method for minimizing boundary effects when switching between halftone screens, includes selecting a first halftone screen having a first fundamental frequency and a first angle for printing pixels of a first type on the scanline; and selecting a second halftone screen having a second fundamental frequency and a second angle for printing pixels of a second type, wherein the second frequency and second angle are harmonically matched to the first frequency and first angle, wherein at least one pixel of the second type is adjacent to a pixel of the first type. The pixels can be adjacent on a scanline or on adjacent scanlines. In one embodiment, the first and second harmonic frequencies are selected to have a substantially zero frequency beat. In another, the first and second harmonic frequencies are selected to have a substantially high frequency beat.

Beat frequency analysis is often used to understand inter-separation moir\acute{e} in process color printing systems. The method described herein uses that analysis for adjoining halftones, rather than overlapping halftones. It has been found that similar requirements for beats frequencies are also valid for adjoining halftones. In accordance with an embodiment disclosed herein, adjacent halftone screens are designed to have matching harmonics. In one embodiment, matched harmonics can be achieved when beats occur either at zero frequency or at very high frequencies. Zero frequency beats can be achieved when the first fundamental frequency is substantially the same as the second harmonic frequency. Zero frequency beats are a good solution for dot screens. High frequency beats may also be an acceptable solution for line screen-to-line screen transitions. High frequency beats can be achieved when the first fundamental frequency is substantially the same as a higher frequency harmonic of the second fundamental frequency.

### BRIEF DESCRIPTION OF THE DRAWINGS

FIG. 1 illustrates exemplary text printed on background by a printer using two halftone screens, one at 212 cpi, 45° dot for the text and one at 70 cpi, 45° dot for the background;

FIG. 2 illustrates a frequency vector diagram of the halftone screens used in FIG. 1;

FIG. 3 illustrates text printed on background using a 212 cpi dot screen for text and a 106 cpi dot screen for the background, both at 45°;

FIG. 4 illustrates a frequency vector diagram of the halftone screens used in FIG. 3;

FIG. 5 is a schematic of a low frequency dot screen and a high frequency dot screen that share harmonics;

FIG. 6 illustrates an image printed using a 240 cpi 0°/90° dot screen for the text and a 170 cpi at 45° screen for the tint;

FIG. 7 illustrates a frequency vector diagram of the halftone screens used in FIG. 6;

FIG. 8 illustrates an image printed using a 170 cpi 45° dot screen for the background and a 170 lpi line screen at 135° for the text;

FIG. 9 illustrates a frequency vector diagram for halftone screens used in FIG. 8;

FIG. 10 illustrates an image printed using a 240 lpi at 0° line screen for the text and a 170 cpi at 45° dot screen for the background;

FIG. 11 illustrates a frequency vector diagram for the rotated harmonic dot/line screens used in FIG. 10;

FIG. 12 illustrates two adjacent line screens in which the frequency of one line screen is twice that of the other line screen;

FIG. 13 illustrates a frequency vector diagram for the line screens shown in FIG. 12;

FIG. 14 illustrates an image printed using a 106 lpi line screen at 45° for the background and a 212 lpi line screen at 45° for the text; and

FIG. 15 illustrates an image printed using a 106 lpi line screen at 135° for the background and a 212 lpi line screen at 45° for the text.

### DETAILED DESCRIPTION

The method for minimizing boundary effects when switching between halftone screens on a scanline or when switching from scanline to scanline matches the harmonics of adjacent halftone screens to avoid the appearance of low frequency beating defects. Similar to halftones designed to suppress inter-separation moiré, the main requirement is that beats should occur either at zero frequency or at very high frequencies. The condition of zero frequency beats has the effect of eliminating the artifacts caused by beat frequencies visually. Matching frequencies to achieve beats at very high frequencies has the effect of introducing a large number of very small artifacts, which are not visible when viewed by the naked eye.

The following description will focus on matching harmonics in orthogonal halftone screens to achieve a zero frequency beat. High frequency beat solutions will also be described for line-screen-to-line-screen transitions. In the case of orthogonal screens, it can be assumed that the fundamental frequencies of a dot screen are the same in both directions (x, y) and the angles between those frequencies are related by 90°. Several examples of orthogonal halftone screens with matched harmonics and related variants will be described, including: Dot-screen-to-dot-screen, same angles, fundamental frequencies are integer multiples; Dot-screen-to-dot-screen, angles rotate 45°, fundamental frequencies are related by 42; Dot-screen-to-line-screen, same angles, fundamental frequencies are integer multiples; Dot-screen-to-line-screen, angles rotate 45°, fundamental frequencies are related by √2; Line-screen-to-line-screen, same angles, fundamental frequencies are integer multiples; Line-screen-to-line-screen, angles are rotated by 90°, fundamental frequencies are integer multiples.

In the discussion below, the term “orthogonal” is used with respect to halftone screens to indicate that the frequency vectors are at right angles. Most often in the discussion it can be assumed that the orthogonal vectors are the same length, i.e., the halftone cell shape is square. The term “nonorthogonal” is used herein as some experts in the field use it to mean not necessarily square. Thus, the class of nonorthogonal screens comprise the orthogonal class. The frequency vectors could vary from 90°, and the length of the vectors may not be equal.

Harmonics generally refers to the each of the fundamental frequency vectors and sums of multiples of those vectors. Matched harmonics means that some number of resolvable harmonics match. If all harmonics matched, then the screen would be at the same frequency and angle, and would not provide a useful solution. Further, the harmonics of interest are those that are resolved by the marking processing. It is not useful to match harmonics that are well beyond the resolution of a printer. The frequency vectors of the halftone screen are sometimes referred to as the fundamental frequencies. The next higher harmonic is formed by the addition of the two closest frequency vectors and this harmonic is referred to as the first harmonic. The next higher harmonic is formed by doubling each of the fundamental frequency vectors. This harmonic is referred to as the second harmonic.

The method of minimizing boundary effects when switching between halftone screens can be used in various color and monochrome printing applications. In the case of color printing, the method can be applied to each color separation. The most straightforward application is to monochrome printing where the one colorant, such as black, is halftoned using the method of minimizing boundary effects when switching between halftone screens. Another aspect is in a color setting where at least one, but possible more, (a plurality) of the color separations are individually halftoned using the method of minimizing boundary effects when switching between halftone screens. For instance, in a color image, cyan could be halftoned using the method of minimizing boundary effects when switching between halftone screens.

Another embodiment of the method of minimizing boundary effects when switching between halftone is its application in a color image across color separations. For example, black text on a cyan background could benefit from the principles of the method of minimizing boundary effects when switching between halftone screens. A related aspect is the application to process color (multiseparation) objects. In that case, harmonics of the different color separations can be matched where the halftone is most visible in the two objects. For example, a background tint that is colored “light sky blue” will have a middle amount of cyan and very little magenta. The cyan halftone screen will be the most visible. Text that is “dusty rose” in color will contain black and magenta, and for some shades of the color the black screen will be the most visible. The method of minimizing boundary effects when switching between halftone screens can be applied to the cyan in the light sky blue background and the black in the dusty rose text.

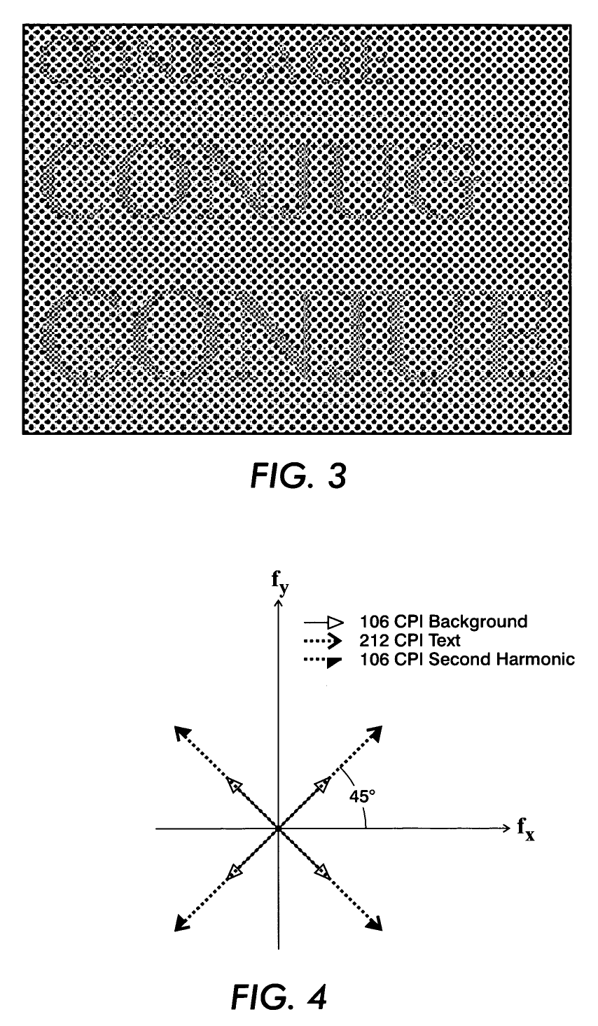

Dot-screen-to-dot screen, same angles, integer multiple frequencies. Referring to FIG. 3, text over a background was printed using two halftone screens with matched harmonics in which the fundamental halftone frequencies of the adjacent halftone dot screens have an integer multiple frequency relationship and the same phase angles. In the image in FIG. 3, text was printed using a dot screen having a fundamental frequency of 212 cpi and angle of 45°. (Note that cpi is defined as cycles per inch. This could be used as a measure of frequency for line screens or dot screens, but is typically limited in use to dot screens.) The background was printed using a dot screen having a fundamental frequency of 106 cpi and angle of 45°. Harmonics of the screens are matched, and thus do not produce objectionable beats at the boundary. Note that the frequency of the text halftone screen is 2 times the frequency of the background halftone screen. FIG. 4 shows the fundamental frequency vectors for the 212 cpi text at 45° is matched to second harmonics of the 106 cpi.

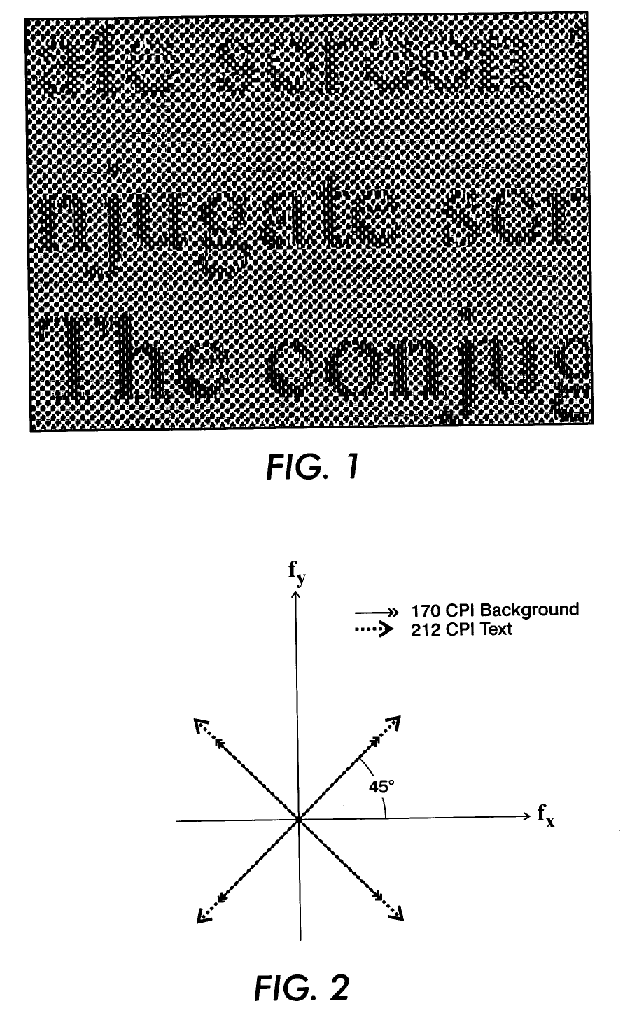

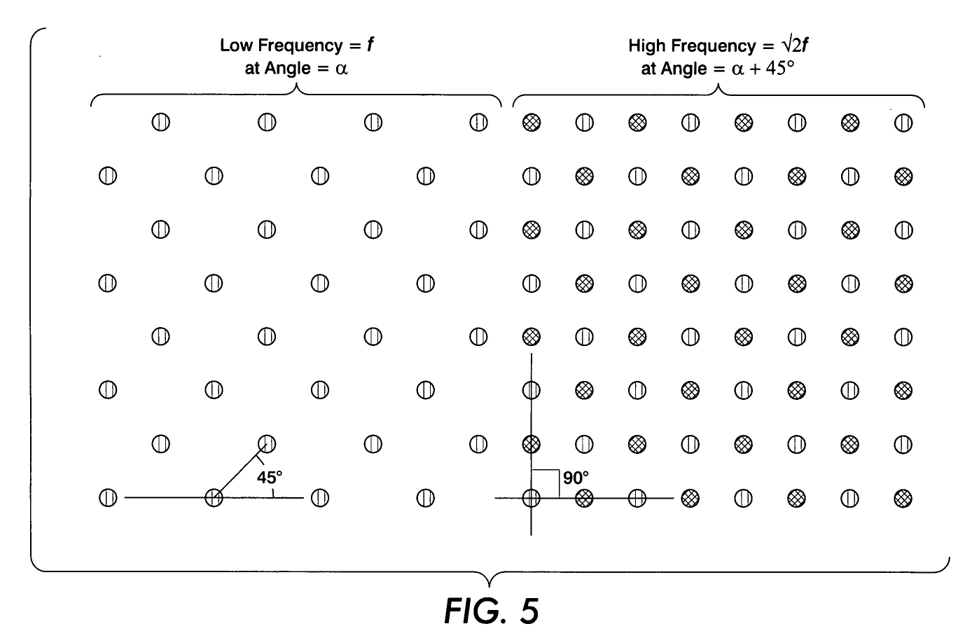

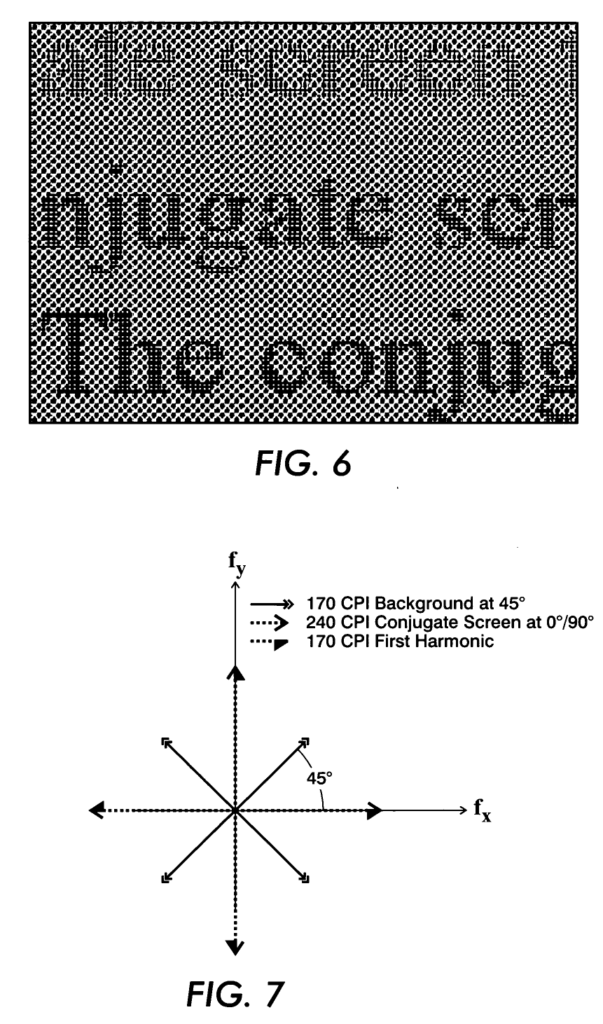

Dot-screen-to-dot-screen, angles rotate 45°, fundamental frequencies are related by √2. Referring to FIG. 5, a schematic of a dot screen pair is illustrated. In FIG. 5, the low frequency dot screen has a frequency f and angle α. The high frequency dot screen has a frequency √f and angle of α+45°. The fundamental frequency of the low frequency screen is shown as dark circles. In the high frequency screen those same dots are shown with additional dots placed midway between the dark dots. The two screens have common frequency components, i.e., matched harmonics. FIG. 6 shows an image halftoned with the configuration shown in FIG. 5, with the tint (background) halftoned using a 170 cpi 45° dot screen and the text halftoned using a 240 cpi 0°, dot screen. Note that the edge quality is improved, especially for lighter text, compared to the image rendered using the halftones shown in FIG. 1. The frequency vector diagram for this configuration is shown in FIG. 7. FIG. 7 shows that the fundamental frequency of the high frequency screen is the same as the first harmonic of the low frequency screen, with the fundamental low frequency being displaced 45° from the first harmonic.

Dot-screen-to-line-screen, same angles, fundamental frequencies are integer multiples (rotated harmonic screens). Line structure halftone screens and dot structure halftone screens may be preferred for different object types. For example, line screens may be preferred for text because they produce less ragged edges in general over dot screens, and dot screens may be preferred for tints (backgrounds) because the structure is less distracting in uniform areas. Further, it may be desirable for one of these screen types to be at a higher frequency than the other. To obtain a desirable boundary appearance, the fundamental frequencies may be set to be integer multiples, and the angles on one axis may be aligned.

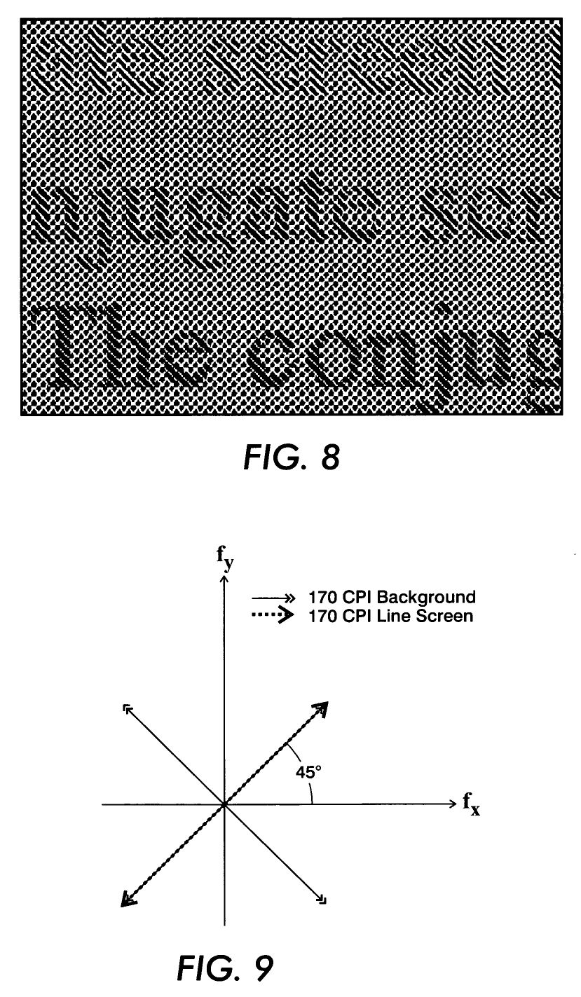

FIG. 8 shows text on tint rendered with a dot screen having a fundamental frequency of 170 cpi and angle of 45° for the tint and 170 lpi at 135° line screen for the text. (Note that lpi means lines per inch. Although some experts in the field of halftoning use these units for a measure of frequency for either line screens or dot screens, its use is limited to line screens for clarity of discussion.) Note the improved appearance of the text over FIG. 1. FIG. 9 shows the frequency vector diagram for this configuration with the 170 lpi line screen aligned with one axis of the 170 cpi background at 45°.

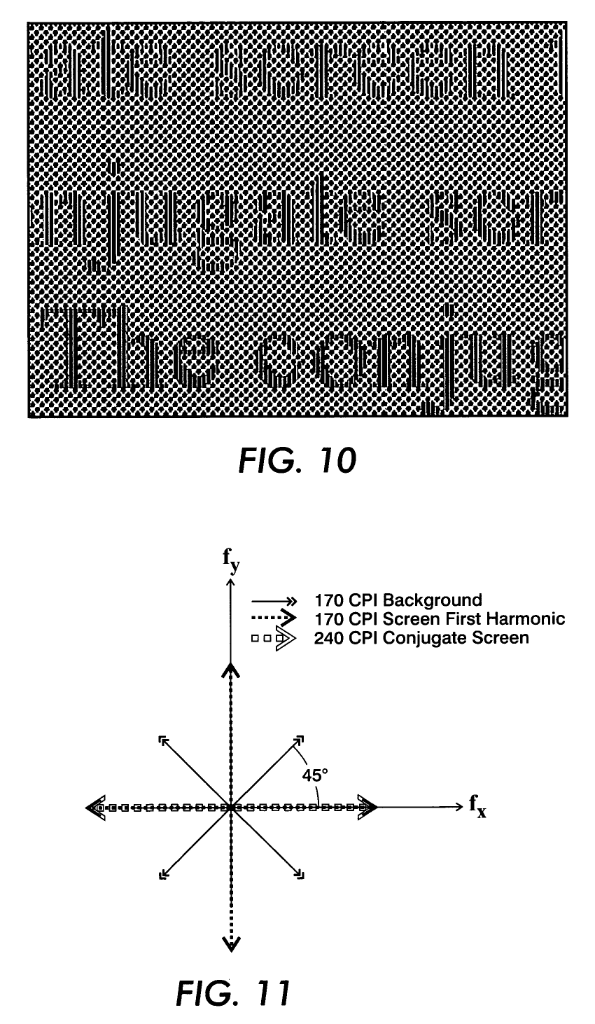

Dot-screen-to-line-screen, angles rotate 45° fundamental frequencies are related by √2 (rotated harmonic dot/line screens). This example is similar to the configuration in which the adjacent halftone screens are both dot screens as described above. In this example, a line screen and a dot screen are paired such than the fundamental frequency of one is coincident with a harmonic of the other. FIG. 10 shows an example where the background is halftoned with a 170 cpi 45° dot screen and the text is halftoned with a 240 lpi 0° (90°) line screen. The frequency vector diagram is shown in FIG. 11 in which the first harmonic of the 170 cpi background screen is perpendicular to the 240 lpi conjugate line screen at 0°.

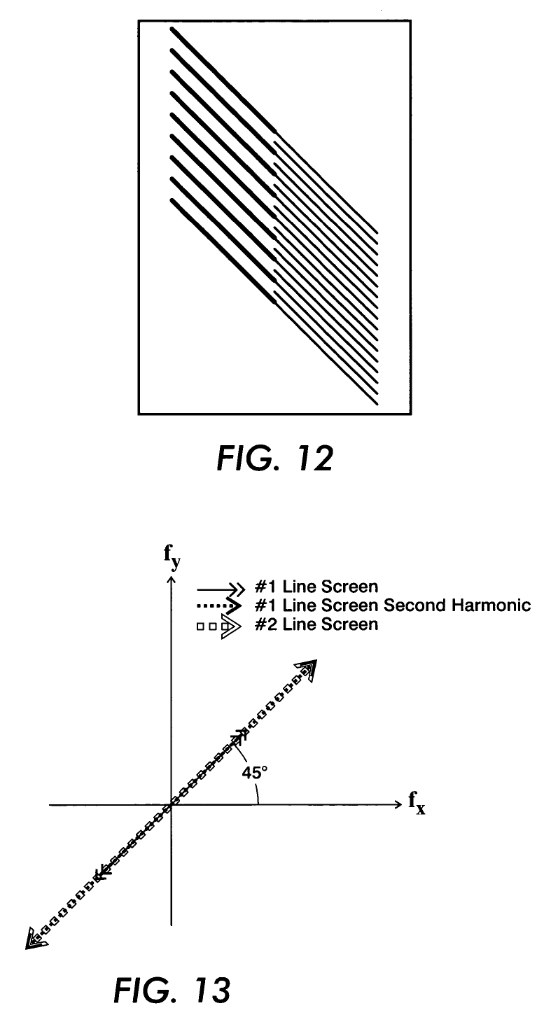

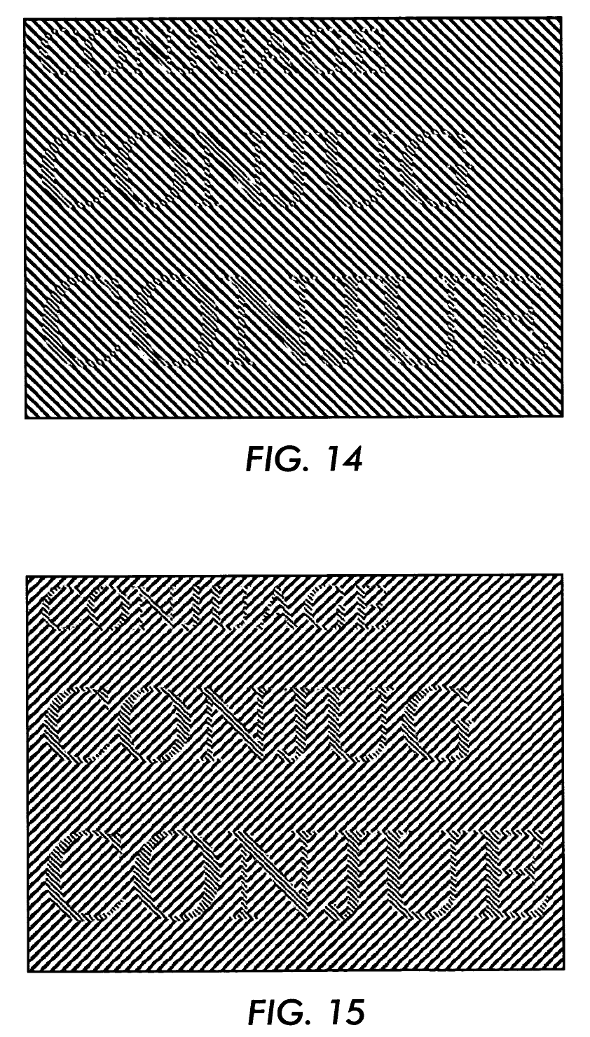

Line-to-line screens, same angles, integer multiple frequencies. In some printing applications, it may be appropriate to use adjacent line screens. Adjacent line screens that possess an integer-multiple frequency relationship have harmonics that are matched, thereby avoiding objectionable beats. FIG. 12 shows an example of an intersection of two such line screens in which one line screen has a line frequency that is twice that of the adjacent line screen. FIG. 13 shows the frequency vector diagram for this configuration. Note that the first line screen at 106 lpi and 45°, the second harmonics of the first line screen at 45° and the second line screen at 212 lpi and 45° are all matched. FIG. 14 shows an image example where the text has been printed using a line screen at 212 lpi and 45° over a background printed using a line screen at 106 lpi and 45°.

Line-to-line screens, angles rotated by 90°, frequencies are set as desired. All of the preceding examples produced adjacent halftone screens with zero beat frequency. In some applications, it may be appropriate to have a high beat frequency solution, such as for line screens. In this configuration, frequencies of the line screens are set as desired and the line screen angles are rotated by 90°. This configuration is chosen to result in a beat at a frequency high enough to be visually acceptable. An example is of an image printed using a 212 lpi line screen at 45° for the text and a 106 lpi line screen at 135° for the background is shown in FIG. 15.

Additional considerations. The above discussion assumed orthogonal halftone screens because it was simpler to describe the concepts using the assumption that the fundamental frequencies of a dot screen were the same in both directions and the angles between those frequencies were related by 90°. Some halftone screens are constructed based on nonorthogonal cells. The concept of the desirability of matched harmonics still applies. The only difference is that the design must account for the different frequency vectors, and not assume they are the same in both directions.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for minimizing boundary effects when switching between halftone screens, comprising:
selecting a first halftone screen having a first fundamental frequency and a first angle for printing pixels of a first type on the scanline; and
selecting a second halftone screen having a second fundamental frequency and a second angle for printing pixels of a second type, wherein the second frequency and second angle are harmonically matched to the first frequency and first angle, wherein at least one pixel of the second type is adjacent to a pixel of the first type.

2. The method of claim 1, wherein at least one pixel of the second type is adjacent to a pixel of the first type on a scanline.

3. The method of claim 1, wherein at least one pixel of the second type is adjacent to a pixel of the first type on adjacent scanlines.

4. The method of claim 1, wherein the first fundamental frequency matches a second harmonic frequency of the second halftone screen.

5. The method of claim 1, wherein the first fundamental frequency matches a higher frequency harmonic frequency of the second halftone screen.

6. The method of claim 1, wherein the first and second halftone screens comprise dot screens and wherein the first fundamental frequency is an integer multiple of the second fundamental frequency.

7. The method of claim 1, wherein the first and second halftone screens comprise dot screens and wherein the first and second angles are rotated 45° from one another and the first fundamental frequency is √2 multiple of the second fundamental frequency.

8. The method of claim 1, wherein the first halftone screen comprises a dot screen and the second halftone screen comprises a line screen; wherein the first and second angles are substantially the same; and wherein the first fundamental frequency is an integer multiple of the second fundamental frequency.

9. The method of claim 1, wherein the first halftone screen comprises a dot screen and the second halftone screen comprises a line screen and wherein the first and second angles are rotated 45° from one another and the first fundamental frequency is √2 multiple of the second fundamental frequency.

10. The method of claim 1, wherein the first and second halftone screens comprise line screens having the same angle and wherein the first fundamental frequency is an integer multiple of the second fundamental frequency.

11. The method of claim 1, wherein the first and second halftone screens comprise line screens and wherein the first and second angles are rotated 90° from one another and wherein the first fundamental frequency is an integer multiple of the second fundamental frequency.

12. The method of claim 1, wherein the first and second halftone screens comprise nonorthogonal cells.

13. A method for minimizing boundary effects when switching between halftone screens for adjacent objects, comprising:
selecting a first halftone screen having a first fundamental frequency and a first angle for printing pixels of a first object type; and
selecting a second halftone screen having a second fundamental frequency and a second angle for printing pixels of a second object type, wherein the second frequency and second angle are harmonically matched to the first frequency and the first angle, wherein at least one pixel of the second object type is adjacent to a pixel of the first object type.

14. The method of claim 13, wherein the first and second halftone screens are in the same color separation.

15. The method of claim 13, wherein the first halftone screen is in a first color separation and the second halftone screen is in a second color separation.
